(19) United States
(12) Patent Application Publication
(10) Pub. No.: US 2005/0001355 A1
(43) Pub. Date: Jan. 6, 2005

(54) Method and an apparatus for the production of plastic parts

(76) Inventors: Per Gustafsson, Barred (SE); Stefan Forss, Helsgingborg (SE)

Correspondence Address: BURNS DOANE SWECKER & MATHIS L L P, POST OFFICE BOX 1404, ALEXANDRIA, VA, 22313-1404, US

(21) Appl. No.: 10/500,976

(22) PCT Filed: Jan. 14, 2003
(86) PCT No.: PCT/SE03/00040

(30) Foreign Application Priority Data
Jan. 21, 2002 (SE) 0200195-6

(51) Int. Cl. B29C 45/00

(52) U.S. Cl. 264/297.2; 264/328.1; 264/328.14; 264/328.16; 425/542

(57) ABSTRACT

In a method for producing plastic parts, which comprises the step that the plastic parts are injection-moulded by means of a moulding tool (5; 107), the moulding tool (5; 107) is displaced after the injection-moulding together with the plastic part. An apparatus for the production of plastic parts is also described. The apparatus has an injection-moulding nozzle (23) and a moulding tool (5; 107) with co-operating mould parts or halves (6), the tool having an open and a closed position. Further, the apparatus has means (2; 100) for displacing each plastic part in relation to an injection-moulding position where injection-moulding takes place and means (2; 108, 109) for displacing the moulding tool (5; 107) in the closed state together with the plastic part.

### TECHNICAL FIELD

The present invention relates to a method for producing plastic parts which comprises the step that the plastic parts are injection-moulded by means of a moulding tool. The present invention also relates to an apparatus for producing plastic parts, the apparatus having an injection nozzle, a moulding tool with co-operating mould parts which has an open and a closed position, as well as means for displacing each plastic part in relation to an injection-moulding position in which injection-moulding takes place.

### BACKGROUND ART

Methods and apparatuses of the type described by way of introduction are previously known, for example from WO 98/18608, in which opening arrangements are injection-moulded direct in apertures in a material web which is subsequently formed into packages.

EP-A-862 980 describes a method and an apparatus in which end walls of plastic are injection-moulded on one end of a sleeve for forming a blank for a packaging container. Sleeves are fed onto mandrels in a mandrel wheel which is rotated so that the sleeves are moved one by one to a moulding tool with an injection-moulding nozzle where an end wall is formed at the end of the sleeve. The packaging blank produced thereby is further rotated to a cooling station and then to a discharge station where it is removed from the mandrel.

One problem in the injection-moulding of plastic parts is that they must cool so as not to be deformed when the moulding tool is removed. As a result, sufficient time must be given in the manufacturing process for cooling in the moulding tool. If this time is extended, the process becomes, however, slower which is economically disadvantageous.

### SUMMARY OF THE INVENTION

The object of the present invention is therefore to realise a method for the production of plastic parts which makes for a sufficient cooling time without the manufacturing process becoming excessively slow. A further object of the present invention is to realise an apparatus for producing plastic parts which has been improved compared with prior art technology.

These objects will be attained according to the present invention in that the method of the type described by way of introduction is given the characterising feature as set forth in appended claim 1. Preferred embodiments of the method are apparent from appended subclaims 2 to 11. The object of the present invention will also be attained by means of an apparatus as set forth in appended claim 12, with preferred embodiments as disclosed in the appended subclaims 13 to 33.

The method according to the present invention thus utilises the feature that the moulding tool is, after the injection-moulding, displaced together with the plastic part. By such means, the cooling time of the plastic part in the moulding tool may be increased without the manufacturing process becoming slower. Moreover, prior to the injection-moulding, the moulding tool is closed, the moulding tool is subjected to a first force for holding it together, an injection-moulding nozzle is positioned in the moulding tool and the moulding tool is subjected to a second force which is greater than the first force for holding it together, and, after the injection-moulding, the method incorporates the step that the moulding tool is relieved of load. An injection-moulding may hereby be carried out with good precision.

According to one variation of the method according to the present invention, each plastic part is allowed to cool during the displacement operation, which extends the cooling time.

According to yet a further variation of the method according to the present invention, each plastic part is displaced after the injection-moulding in relation to an injection-moulding position in which the injection-moulding takes place, to a cooling position. This contributes in improved cooling.

Preferably, each plastic part is permitted to cool in the cooling position, which further prolongs the cooling time.

The first force may advantageously place the moulding tool under load during the displacement operation. As a result, the moulding tool is held reliably together.

According to a further variation of the method according to the invention, the moulding tool is opened after the displacement operation. By such means, the plastic part remains in the moulding tool during the displacement.

According to one preferred embodiment of the method according to the present invention, injection-moulding of a plastic part in the injection-moulding position takes place at the same time as another, previously injection-moulded plastic part is located in the cooling position. This renders the manufacturing process more efficient, since injection-moulding of one plastic part may be commenced before a previously injection-moulded plastic part has completely cooled.

In one variation of the method, a plastic part is injection-moulded in the form of a top section on one end of a sleeve for the formation of a packaging container. This is a rational method of manufacturing packaging containers.

Preferably, the sleeve is positioned in relation to the moulding tool on the positioning of the injection-moulding nozzle. Accurate precision will thereby be obtained in the positioning of the top section on the end of the sleeve.

According to another variation of the method according to the present invention, plastic parts are injection-moulded in the form of opening arrangements in apertures in a material web. This is a rational method of disposing opening arrangements in the material web. The material web may subsequently be formed into packaging containers.

Advantageously, the material web is positioned in relation to the moulding tool on the positioning of the injection-moulding tool, which affords a high degree of precision in the positioning of the opening arrangements in the material web.

The apparatus according to the present invention utilises means for displacing the moulding tool in its closed state together with the plastic part. This makes possible a prolonged cooling time at the same time as production output rate can be kept high. The apparatus further displays a union device for unifying the mould parts during the injection-moulding. This ensures that the moulding tool is held together during the injection-moulding.

The union device is furthermore disposed to apply a first force and a second force on the mould parts for holding them together, the second force being greater than the first. As a result, certain adjustments in the united moulding tool may be put into effect before the greater force is applied, which ensures the unity of the moulding tool during the injection-moulding.

In one embodiment, the apparatus has a cam mechanism for opening and closing, respectively, of the moulding tool by displacement of the mould halves away from and towards one another, respectively. There will thereby be obtained a reliable mechanical control of the opening and closing of the moulding tool.

The apparatus may further be provided with retainer means for supporting and displacing the mould parts. This facilitates opening and closing of the moulding tool.

Preferably, each retainer means has a wheel which is disposed to follow a cam groove. This makes possible, in a simple manner, opening and closing of the moulding tool.

The wheels may be spring-biased, which renders the guiding and controlling of the mould halves less sensitive to wear to the cam groove.

The apparatus according to the present invention may further be provided with means for positioning the injection-moulding nozzle in the moulding tool. This makes for a high degree of precision in the injection-moulding.

The union device is provided, in one embodiment, with a spring for applying the first force. This is a simple and reliable method of realising the unity of the moulding tool.

The union device may further be provided with a cylinder for applying the second force. By such means, a large second force may be generated in a reliable manner.

According to one embodiment of the present invention, the means for displacing the moulding tool includes a rotary hub and at least one arm projecting radially outwardly from the hub, and at whose radial outer end the moulding tool is disposed. By such means, the moulding tool may simply be moved together with the plastic part.

According to one preferred embodiment of the apparatus according to the present invention, the means for displacing the moulding tool has five radial arms, one moulding tool being disposed at the radial outer end of each arm with symmetric distribution around the hub. This arrangement makes for efficient manufacture of plastic parts since injection-moulding may be put into effect in one moulding tool while cooling is in progress in another.

The moulding tool is advantageously disposed to be moved into and out of the union device by rotation about the hub. This is a simple manner of inserting the moulding tool into the union device.

In yet a further preferred embodiment of the apparatus according to the present invention, the means for displacing the moulding tool consists of pairwise disposed drive means. Reliable displacement of the moulding tool may hereby be realised.

The apparatus according to the present invention further preferably includes means for advancing a material web in a direction of advancement on which the plastic parts are to be injection-moulded and at which the drive means are disposed on either side of a position in which the material web is advanced. As a result, the mould parts of the moulding tool may simply and reliably be applied against the material web.

The drive means are advantageously disposed to displace the moulding tool in the direction of advancement of the material web at a speed displacement which is substantially the same as the speed of advancement at which the material web is advanced. A rapid and reliable manufacturing process will thereby be ensured, since the material web need not be retarded during the cooling period.

Preferably, at least two moulding tools are disposed on each drive means, which makes possible a rapid manufacturing process, since the injection-moulding may be carried out in one moulding tool while cooling proceeds in another.

The drive means may comprise a rotary wheel, which is a mechanically simple method of displacing the moulding tools.

According to one alternative, the drive means may consist of endless belts.

According to yet another alternative, the drive means may consist of endless chains.

In one preferred embodiment, the apparatus according to the present invention is disposed to produce plastic parts in the form of top sections for packaging containers on one end of a sleeve of laminated paperboard. This makes for efficient production of packaging containers of paperboard with a plastic top.

According to another preferred embodiment, the apparatus according to the invention is disposed to produce plastic parts in the form of opening arrangements in a material web of laminated paperboard intended for the production of packaging containers. With such an apparatus, opening arrangements may, in an efficient manner, be provided in the material web which may thereafter be formed into packaging containers.

### BRIEF DESCRIPTION OF THE ACCOMPANYING DRAWINGS

The present invention will now be described in greater detail hereinbelow, with reference to the accompanying Drawings which, for purposes of exemplification, illustrate currently preferred embodiments of the present invention.

In the Accompanying Drawings:

FIG. 1 is a front elevation of an apparatus according to a first embodiment of the apparatus according to the invention;

FIG. 2 is a section taken along the line II-II through a part of the apparatus of FIG. 1;

FIG. 3 is a magnified view of a part according to the marking III in FIG. 2;

FIG. 4 is a perspective view of parts of a second embodiment of the apparatus according to the invention;

FIG. 5 is a schematic side elevation of a drive means intended for the apparatus according to FIG. 4; and

FIG. 6 is a schematic side elevation of alternative drive means intended for the apparatus of FIG. 4.

### DESCRIPTION OF PREFERRED EMBODIMENTS

Both the method and the apparatus according to the present invention will be described below.

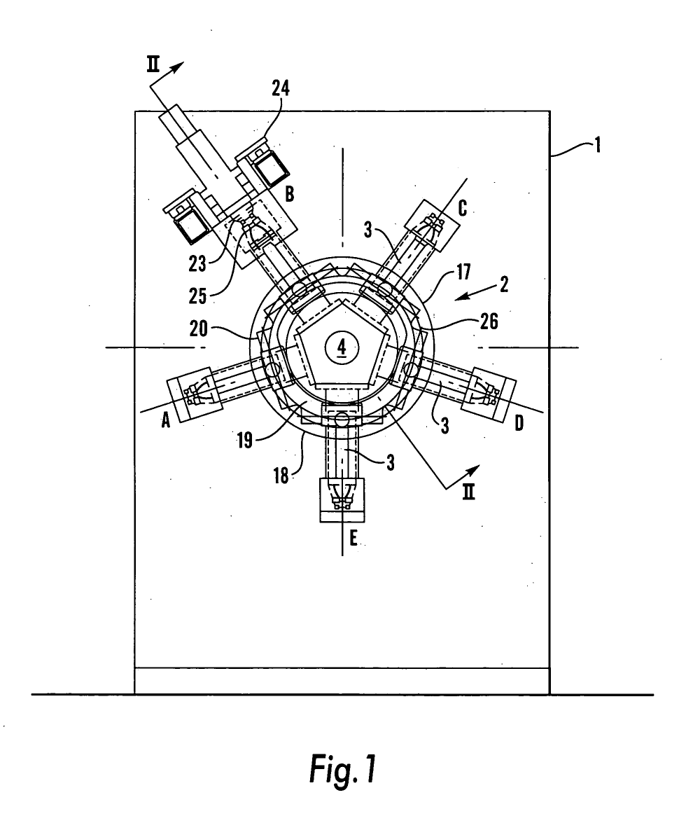

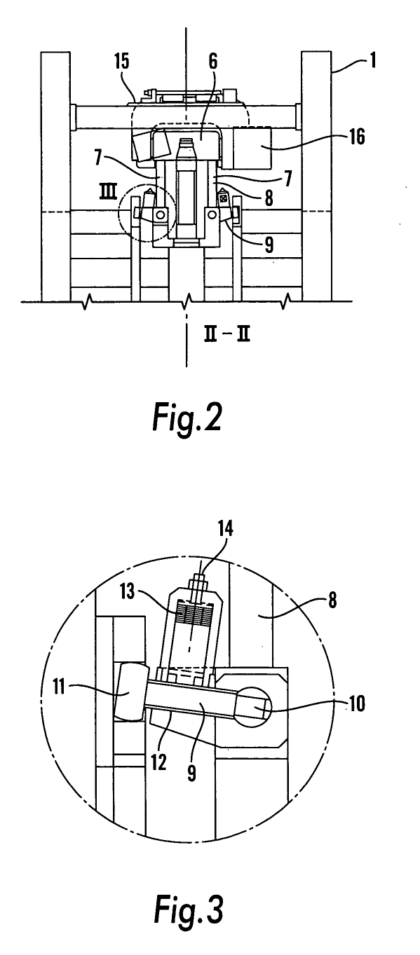

In a first embodiment according to FIGS. 1-3, the apparatus has a frame 1 in which a mandrel wheel 2 is mounted. Five mandrels 3 extend radially outwards from the hub 4 of the mandrel wheel 2. On the radially outer end of each mandrel 3 there is disposed a moulding tool 5 with two outer mould parts 6. The outer end region of the mandrel 3 constitutes an inner mould part in the moulding tool 5. Each outer mould part 6 is secured to the end of a L-shaped retainer 7. The retainer 7 consists of a substantially vertical shank 8 and a substantially horizontal shank 9 which are secured to one another by means of a pivot 10. At its end facing away from the pivot 10, the horizontal shank 9 has a wheel 11. A spring 13 with a setting screw 14 is connected to the horizontal shank 9 of the retainer 7. On the horizontal shank 9, a sleeve 12 is further disposed. In the frame 1, a unity device in the form of a brake caliper 15 is freely suspended. The brake caliper 15 has a cylinder 16. The apparatus has a cam mechanism 17 with a cam disc 18 in which there is disposed a cam groove 19. The apparatus further displays an injection-moulding nozzle 23 and an adjustment mechanism 24.

The mandrel wheel 2 is rotatable about the hub 4. When the mandrel wheel 2 is rotated, each mandrel 3 with the moulding tool 5 passes five productions stations A-E. At an applicator station A, a sleeve 22 of laminated paperboard is passed on the mandrel 3.

The mandrel wheel 2 is rotated clockwise so that the mandrel reaches an injection-moulding station B. During the rotation, the wheels 11 of the retainers 7 follow the cam groove 19 of the cam disc 18 as cam followers. On its way from the applicator station A to the injection-moulding station B, the wheel 11 passes a first deflection 20 in the cam groove 19. This results in the retainers 7 being angled inwards towards the mandrel 3, the outer mould parts 6 being moved towards one another so that the moulding tool 5 is closed. As a result of the spring 13, the moulding tool is held together with a first force which amounts to approx. 1 kN. The mandrel wheel 2 is rotated so that the mandrel 3 with the closed moulding tool 5 is moved into the brake caliper 15. At the injection-moulding station B, an injection-moulding nozzle 23 is inserted into the moulding tool 5. With the aid of the adjustment mechanism 24, the injection-moulding nozzle 23 is positioned in the moulding tool 5 and the paperboard sleeve 22 is positioned in relation to the moulding tool 5 so that the injection-moulding of a top section 25 on the end of the paperboard sleeve 22 may be put into effect with good precision. The cylinder 16 of the brake caliper 15 applies a second force which is greater than the first force and amounts to approx. 20 kN, on the moulding tool 5 so that this is reliably held together during the injection-moulding.

After completion of the injection-moulding, the moulding tool is released from the second force and the mandrel wheel 2 is rotated further clockwise, so that the mandrel 3 reaches a cooling station C. During the displacement from the injection-moulding station B and at the cooling station C, the plastic top 25 which had been injection-moulded on the end of the paperboard sleeve 22 cools.

The mandrel wheel 2 is rotated further clockwise towards a membrane applicator station D. On its way from the cooling station C to the membrane applicator station D, the wheel 11 of the retainer 7 passes a second deviation 26 in the cam groove 19. As a result, the retainers 7 are angled outwards from the mandrel 3, the outer mould parts 6 being displaced away from one another so that the moulding tool 5 is opened. At the membrane applicator station D, a membrane is applied on the plastic top 25 for closure thereof.

The mandrel wheel is then rotated further clockwise to a discharge station E, where the paperboard sleeve 22 with the plastic top 25 is drawn off from the mandrel.

Given that the moulding tool 5 accompanies the plastic top 25 after the injection-moulding, longer time is given for cooling than if the moulding tool 5 were to be removed from the plastic top 25 immediately after the injection-moulding. Since the plastic top 25 has cooled sufficiently before the moulding tool 5 is removed, deformations in the plastic are avoided.

Since one moulding tool is mounted on each mandrel, a plurality of blanks for packaging containers may be-processed at the same time. One paperboard sleeve 22 is passed on a mandrel at the applicator station A, at the same time as a plastic top 25 is injection-moulded on the end of another paperboard sleeve 22 at the injection-moulding station B. A further paperboard sleeve 22 with plastic top 25 cools at the same time at the cooling station C, a membrane is applied on yet a further paperboard sleeve 22 with plastic top 25 at the membrane applicator station D and a paperboard sleeve 22 with plastic top 25 and membrane is drawn off from the mandrel at the discharge station E. In this manner, sufficiently long cooling times can be achieved without the manufacturing process proper becoming slower.

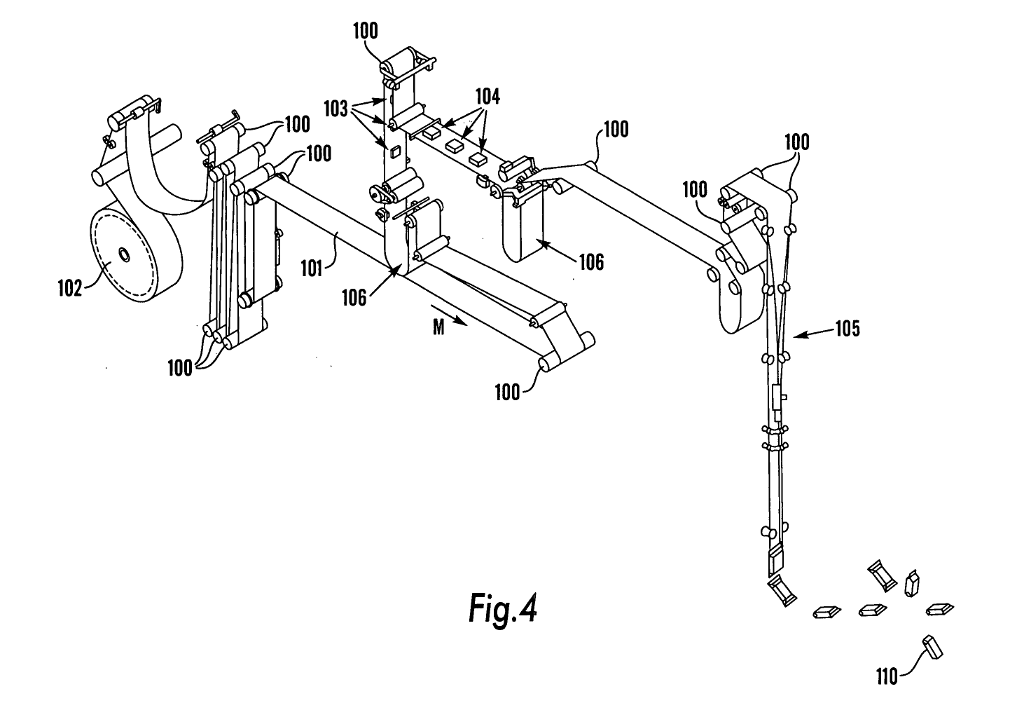

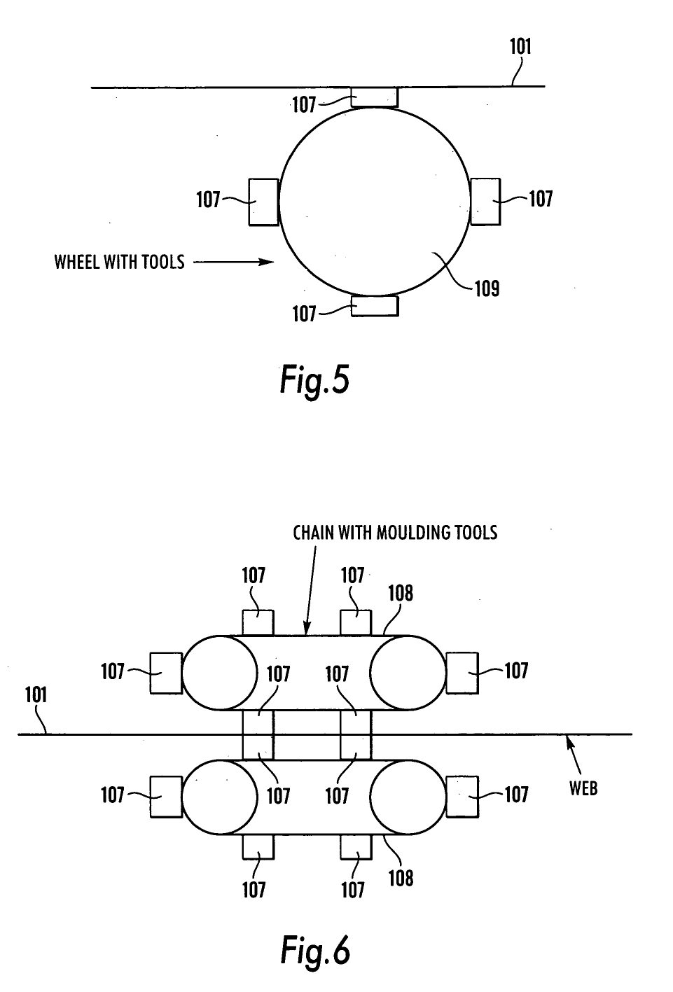

In a second embodiment which is schematically illustrated in FIGS. 4-6, the apparatus has a number of rollers 100 for advancing a material web 101 of laminated paperboard. The paperboard is supplied from a magazine reel 102 and advanced in a direction of advancement M. The apparatus has three adjacent punching stations 103 and, downstream thereof in the direction of advancement M, three injection-moulding stations 104. Further downstream, there is a forming section 105. Upstream of the punching stations 103 and downstream of the injection-moulding stations 104 there are buffer zones 106. At the injection-moulding stations, there are moulding tools 107 which are mounted on drive means in the form of endless chains or belts 108 or rotary wheels 109.

Paperboard in the form of the material web 101 is fed from the magazine reel 102 with the aid of the rollers 100 to the punching stations 103, where the web 101 is retarded and holes are punched in the paperboard. For compensation for the retardation of the material web 101, the buffer zone 106 is disposed upstream of the punching stations 103 where the web is permitted to hang down.

The web 101 is advanced further so that the punched holes reach the injection-moulding stations 104. Here, the web 101 is once again retarded. This retardation is compensated for with the aid of a buffer zone 106 downstream of the injection-moulding stations 104. The moulding tools 107 are brought, with the aid of the drive means in the form of endless chains 108 or wheels 109, into contact with the material web 101. In the same manner as in the above described first embodiment, each moulding tool 107 is opened and closed by means of a cam mechanism. The moulding tools are also here held together by spring force. An injection-moulding nozzle (not shown) is inserted into the moulding tool and positioned there. Around the material web 101, there is disposed a brake caliper (not shown) at the injection-moulding stations 104. As in the previously described first embodiment, the brake caliper has a cylinder by means of which a force is applied on the moulding tools 107 so that these are reliably held together. An opening arrangement is injection-moulded in each hole in the material web 101, whereafter the force of the brake caliper on the moulding tool is released. The material web 101 is advanced further, but the moulding tools are kept still closed by the spring force, so that the opening arrangements are given time to cool. With the aid of the cam mechanism, the moulding tools 107 are subsequently opened.

The material web 101 is advanced further to the forming section 105 where it is formed into packaging containers 110.

This embodiment of the apparatus according to the present invention may be varied so that the injection-moulding is, instead of taking place intermittently, put into effect continuously so that the material web 101 need not be retarded. In such an event, the buffer zones 106 are not necessary. In such a case, the injection-moulding stations are not discrete points but rather extremely short dashes in the direction of advancement M.

Like the first embodiment, the apparatus according to this second embodiment ensures sufficient cooling times for the injection-moulded plastic parts in that the moulding tool 107 is kept closed and accompanies the plastic part a distance in the direction of advancement M.

In that a plurality of moulding tools 107 are disposed on each drive means 108, 109, an opening arrangement may be injection-moulded in a moulding tool 107 at the same time as another opening arrangement cools in another moulding tool 107.

In both embodiments, the design of the retainers 7 with the sleeve 12 and the spring 13 ensures that the opening and closing function for the moulding tool 5, 107 functions reliably even if the cam groove 19 has become worn. With a retained angle between the shanks 8, 9 of the retainer 7, the retainer may rotate about the pivot 10 until the horizontal shank 9 enters into abutment with the inside of the sleeve 12. When this movement space has been utilised, the spring 13 is biased. The setting screw 14 makes it possible to pretension the spring 13 to the desired degree.

The present invention has been described in conjunction with the manufacture of plastic parts for packaging containers, but may naturally also be employed in other contexts where plastic parts are injection-moulded.

1. A method for the production of plastic parts, comprising the steps that
the plastic parts are injection-moulded by means of a moulding tool, and
the moulding tool is, after the injection-moulding, displaced together with the plastic part,
wherein it further includes the steps that
the moulding tool is closed,
the moulding tool is subjected to a first force for holding together thereof;
an injection-moulding nozzle is positioned in the moulding tool; and
the moulding tool is subjected to a second force which is greater than the first force for holding together thereof;
and, after the injection-moulding, the step that
the moulding tool is released of loading.

2. The method as claimed in claim 1, wherein each plastic part is permitted to cool during the displacement.

3. The method as claimed in claim 1, wherein each plastic part, after the injection-moulding, is displaced in relation to an injection-moulding position to a cooling position.

4. The method as claimed in claim 3, wherein each plastic part is permitted to cool in the cooling position.

5. The method as claimed in claim 1, wherein the moulding tool is subjected to the first force during the displacement.

6. The method as claimed in claim 1 wherein the moulding tool is opened after the displacement.

7. The method as claimed in claim 1, wherein injection-moulding of a plastic part takes place in the injection-moulding position at the same time as another previously injection-moulded plastic part is located in the cooling position.

8. The method as claimed in claim 1, wherein a plastic part in the form of a top section is injection-moulded on one end of a sleeve for forming a packaging container.

9. The method as claimed in claim 8, wherein, in the positioning of the injection-moulding nozzle, the sleeve is positioned in relation to the moulding tool.

10. The method as claimed in claim 1, wherein plastic parts in the form of opening arrangements are injection-moulded in apertures in a material web.

11. The method as claimed in claim 10, wherein, in the positioning of the injection-moulding nozzle, the material web is positioned in relation to the moulding tool.

12. An apparatus for producing plastic parts, the apparatus having an injection-moulding nozzle, a moulding tool with co-operating mould parts or halves, which has an open and a closed position, as well as means for displacement of each plastic part in relation to an injection-moulding position where injection-moulding takes place, and means for displacement of the moulding tool in the closed state together with the plastic part, wherein it further comprises a unity device for holding together the mould parts during the injection-moulding, wherein the unity device is disposed to apply a first force and a second force on the mould parts for holding together thereof, the second force being greater than the first.

13. The apparatus as claimed in claim 12 which further displays a cam mechanism for opening and closing, respectively, of the moulding tool by displacement of the mould parts away from and towards one another, respectively.

14. The apparatus as claimed in claim 13, which further displays retainer means for supporting and displacing the mould parts.

15. The apparatus as claimed in claim 14, wherein each retainer means has a wheel which is disposed to follow a cam groove.

16. The apparatus as claimed in claim 15, wherein the wheel is spring-biased.

17. The apparatus as claimed in claim 12, which further displays means for positioning the injection-moulding nozzle in the moulding tool.

18. The apparatus as claimed in claim 12, wherein the unity device has a spring unit for applying the first force.

19. The apparatus as claimed in claim 12, wherein the unity device has a piston and cylinder assembly for applying the second force.

20. The apparatus as claimed in claim 12, wherein said means for displacing the moulding tool comprises a rotary hub and at least one arm projecting radially out from the hub and at whose radial outer end the moulding tool is disposed.

21. The apparatus as claimed in claim 20, wherein said means for displacing the moulding tool has five radial arms, one moulding tool being disposed at the radial outer end of each arm with symmetric distribution about the hub.

22. The apparatus as claimed in claim 20, wherein the moulding tool is disposed to be inserted in and removed from the unity device by rotation about the hub.

23. The apparatus as claimed in claim 12, wherein said means for displacing the moulding tool comprise pairwise disposed drive means.

24. The apparatus as claimed in claim 23, which further includes means for advancing, in a direction of advancement, a material web on which the plastic parts are to be injection-moulded and at which said drive means are disposed on either side of a position in which the material web is advanced.

25. The apparatus as claimed in claim 23, wherein said drive means are disposed to displace the moulding tool in the direction of advancement of the material web at a speed of displacement which is substantially the same as a speed of advancement at which the material web is advanced.

26. The apparatus as claimed in claim 24, wherein at least two moulding tools are disposed on each drive means.

27. The apparatus as claimed in claim 23, wherein said drive means comprise rotary wheels.

28. The apparatus as claimed in claim 23, wherein said drive means comprise endless belts.

29. The apparatus as claimed in claim 23, wherein said drive means comprise endless chains.

30. The apparatus as claimed in claim 12, which is disposed to produce plastic parts in the form of top sections for packaging containers by injection-moulding of plastic parts on one end of a sleeve of laminated paperboard.

31. The apparatus as claimed in claim 12, which is disposed to produce plastic parts in the form of opening arrangements in a material web of laminated paperboard intended for the production of packaging containers.
